(19) United States
(12) Patent Application Publication
(10) Pub. No.: US 2019/0261641 A1
(43) Pub. Date: Aug. 29, 2019

(54) Method for Making a Heat-treated Cheese

(71) Applicants: Valerie Arechiga, Twin Falls, ID (US); Michelle Ziemann, St. Charles, MO (US); David Perry, Twin Falls, ID (US); Loren S. Ward, Twin Falls, ID (US); Glanbia Nutritionals (Ireland) Ltd., Kilkenny (IE)

(72) Inventors: Valerie Arechiga, Twin Falls, ID (US); Michelle Ziemann, St. Charles, MO (US); David Perry, Twin Falls, ID (US); Loren S. Ward, Twin Falls, ID (US)

(73) Assignee: Glanbia Nutritionals (Ireland) Ltd., Kilkenny (IE)

(21) Appl. No.: 16/343,770

(22) PCT Filed: Oct. 23, 2017
(86) PCT No.: PCT/US17/57921

§ 371 Date: Apr. 21, 2019

Related U.S. Application Data
(60) Provisional application No. 62/411,457, filed on Oct. 21, 2016.

(51) Int. Cl. A23C 19/082; A21D 13/28; A23C 19/09

(52) U.S. Cl. CPC A23C 19/082; A21D 13/41; A23C 19/0921; A21D 13/28

(57) ABSTRACT

Disclosed is a method for producing cheese products having the desirable properties of process cheese without the use of all or part of the emulsifying salts normally used to produce a process cheese.

### FIELD OF THE INVENTION

The invention relates to methods for making cheeses. More specifically, the invention relates to functional ingredients and methods for making cheese, such as heat-treated (i.e., process-like cheeses), having desirable melting qualities.

### BACKGROUND OF THE INVENTION

For many years, processed cheese has been a diet staple. It can be found in recipes for dishes as varied as macaroni and cheese, dips, appetizers, and casseroles. Slices of processed cheese can be added to other components in sandwiches, or they can form the basis of the sandwich (e.g., grilled cheese). Shredded cheese is a major component of most pizzas. However, according to a November 2014 online article published by Cheese Market News, while consumption of natural cheese in all forms and markets had increased over the past 10 years, consumption of processed cheese had declined (Zimmerman, E., 2015 Trends and Dairy Solutions, Cheese Market News, http://www.cheesemarketnews.com/guestcolumn/2014/21nov14_01.html). One of the reasons for this decline is the public's desire for lower-sodium alternatives.

According to the United States Food and Drug Administration, “[t]he majority of sodium consumed comes from processed and prepared foods, not the salt shaker. This makes it more difficult for all of us to control how much sodium we consume. Some companies have reduced sodium in certain foods, but many foods continue to contribute to high sodium intake, especially processed and prepared foods” (http://www.fda.gov).

Salt is incorporated into cheese for more than just flavor. Salt provides a desirable functionality in cheese production. During the manufacture of natural cheese, salt is added to the curd after the desired pH is reached, helping to control fermentation and proteolysis by regulating starter cultures and enzymes. Salt also lowers the water activity of cheese, preventing the growth of undesirable microorganisms. Process cheese is produced by blending natural cheese(s) with emulsifying salts and other ingredients, then heating and mixing to form a homogeneous product with an extended shelf life. The emulsifying salts make process cheese flow when heated. Emulsifying salts also maintain homogeneity of the melted process cheese, while natural cheese tends to separate and expel the fats and oils from the casein matrix when heating to melting temperature. Emulsifying salts have been a part of cheese production since the early 1900s, when Walter Gerber and Fritz Stettler of Switzerland added sodium citrate to Emmentaler cheese. Around the time of World War I, J. L. Kraft developed a process for pasteurizing cheese to make a more shelf-stable form, for which he received U.S. Pat. No. 1,186,524 in 1916. These two advancements led to the “pasteurized process cheese” that is produced today.

Kapoor and Metzger provide an excellent discussion of the process that takes place when emulsifying salts are added during the manufacture of process cheese (Kapoor, R. and Metzger, L. E., Process Cheese: Scientific and Technological Aspects—A Review, Comprehensive Reviews in Food Science and Food Safety (2008) 7: 194-214). Stated in very simplistic terms, however, there are calcium linkages between caseins in milk, but many more of them form as rennet enzymes cause the proteins to form curds, with calcium providing ionic bridges for coagulation. Calcium ions help hold the proteins together. When sodium citrate is added during the production of process cheese, it replaces the calcium ions with sodium ions. The casein becomes less hydrophobic and more soluble. The disrupted casein complexes also tend to coat the fat particles. This produces a structure that is more flexible than the original natural cheese from which the process cheese is made, and which can still maintain its association with the fat molecules as it is heated, rather than “oiling off” much of the fats/oils. The desirable properties of process cheese that this combination is designed to produce are a tendency of the process cheese to soften upon heating and tendency of the process cheese to spread and flow when completely melted.

Emulsifying salts (ES) are ionic compounds made up of monovalent cations and polyvalent anions. The primary functions of emulsifying salts in process cheese are disruption of the calcium-phosphate-linked protein network present in natural cheese during process cheese manufacture and pH adjustment. Thirteen emulsifying salts are listed in the United States Code of Federal Regulations as approved for use in making process cheese: mono-, di-, and tri-sodium phosphates, dipotassium phosphate, sodium hexametaphosphate, sodium acid pyrophosphate, tetrasodium pyrophosphate, sodium aluminum phosphate, sodium citrate, potassium citrate, calcium citrate, sodium tartrate, and sodium potassium tartrate. It should be noted that most of those compounds contain sodium. According to Zehren and Nusbaum, calcium citrate was added to the list as the result of a request by an industry scientist who recognized that it was also produced during the production of sodium-based ES and in combination worked better than with one emulsifier alone. (Zehren, V. L. and D. D. Nusbaum, Process Cheese, ©1992, Schreiber Foods, Green Bay, Wis., p. 66). The use of a calcium-based emulsifying salt is, however, counter to current reasoning among those of skill in the art such as Galpin et al. (WO2010/140905), who disclosed a method for reducing or eliminating the need for emulsifying salts for making heat-treated cheese, but the method required removing a substantial amount of calcium from the starting material or intermediates in the process. In their disclosure, they stated that “unless the calcium content of the cheese . . . is significantly reduced, process cheese and related products cannot be made without emulsifying salts.” (Page 4, lines 4-6.)

Consumers have recognized a need for lower-sodium products, as well as products with fewer additives. “On the market there is a growing demand from consumers and authorities for food produced without additives, including emulsifying salt, and currently especially sodium.” (Hougaard, A. B. et al., Production of Cheese Powder without Emulsifying Salt: Effect of Processing Parameters on Rheology and Stability of Cheese Feed, Annual Transactions of the Nordic Rheology Society (2013) 21:315-16). According to an October 2016 online article in Food Business News, in 2015, Euromonitor estimated global sales of clean label products to be $165 billion, with $62 billion of that being from North America alone (http://www.foodbusinessnews.net/articles/news_home/Business_News/2016/10/Clean_label_a_$180_billion_gl.aspx?ID={35B6F389-F481-4BF5-8DD1-9BAB90D5EA8B}& cck=1). Reducing or eliminating the use of emulsifying salts could make those cheese products more “clean label.”

The FDA website states that the United States Centers for Disease Control (CDC) “has compiled a number of key studies, which continue to support the benefits of sodium reduction in lowering blood pressure. In some of these studies, researchers have estimated lowering U.S. sodium intake by about 40 percent over the next decade could save 500,000 lives and nearly $100 billion in healthcare costs.” It also states that the World Health Organization has recommended a global reduction in sodium intake and there are 75 countries working to reduce sodium intake—with 39 having already set target sodium levels for one or more processed foods.

The emulsifying salts that are added to processed cheese products increase the sodium content. While the addition of salt is a necessary step in commercial cheese processing, finding a substitute for these emulsifying salts appears to be one approach for decreasing the salt content of process cheese products. For example, Galpin's method (WO2010/140905), involves the use of a “calcium-depleted casein source,” “at least part of which has a proportion of its divalent ions, including calcium ions, replaced with sodium or potassium ions.” Insoluble calcium is then added during the process of making the processed cheese. While emulsifying salts are not added during the heat treatment of the shredded cheese, the method still requires the addition of a substantial amount of sodium and/or potassium—enough to produce a similar effect to that obtained if emulsifying salts are used to make processed cheese. Furthermore, methods such as these require the additional step of producing or obtaining a “calcium-depleted casein source,” adding to the manufacturing cost.

What are needed are new and better compositions and methods for reducing and/or eliminating the use of emulsifying salts in processed cheese.

### SUMMARY OF THE INVENTION

The invention relates to a method for making a heat-treated cheese, the method comprising admixing with at least one shredded natural cheese a composition comprising at least one inorganic calcium composition, wherein the calcium composition provides a functional substitute for at least one emulsifying salt, and heat-treating the shredded natural cheese and at least one inorganic calcium composition to produce a heat-treated cheese. In various embodiments, the invention also comprises a method for making a heat-treated cheese, the method comprising admixing with at least one shredded natural cheese a composition comprising calcium and phosphate, the ratio of calcium to phosphate in the composition being from about 4:1 to about 1:1, and heating the shredded cheese and calcium composition to produce a heat-treated cheese. In various embodiments, the composition can be selected from the group consisting of milk mineral, inorganic calcium, inorganic phosphorus, and combinations thereof. In some embodiments, the milk mineral is isolated from bovine milk. In various embodiments, the calcium composition can be added after the cheese is shredded, and in various embodiments, the calcium composition can be added before the cheese is shredded (e.g., during the cheesemaking process for the natural cheese).

In various embodiments, the invention relates to a method for making a heat-treated cheese, the method comprising admixing with at least one natural cheese a calcium composition selected from the group consisting of at least one calcium-containing mineral composition isolated from a biological source. In various embodiments, the biological source is selected from the group consisting of mammalian milk, plant tissue, algae, bacteria, and combinations thereof. In some embodiments, the calcium composition from mammalian milk comprises an isolated milk mineral composition from bovine milk. In some embodiments, the milk mineral comprises from about 0.25 percent to about 3 percent (w/w) of the heat-treated cheese. In various embodiments, the milk mineral can be milk mineral that has been isolated from the milk of domestic cattle. In various embodiments, the at least one natural cheese is shredded prior to the addition of the milk mineral, and in various embodiments, the milk mineral is added before the natural cheese is shredded. In various embodiments, inorganic calcium and phosphate (e.g., calcium phosphate) can be used at a level of from about 0.25% to about 3% w/w of heat-treated cheese.

Various aspects of the method of the invention further comprise the steps of melting the shredded cheese by the addition of heat to produce a melted cheese, and transferring the melted cheese to at least one device for cooling and forming the cheese. In various embodiments, the at least one device can be a container to hold the cheese as it cools, taking the shape of the internal dimensions of the container, and/or such a device can be a cooling belt, casting line, or a similar device that is known to those of skill in the art for forming, shaping, and cutting processed cheese to form slices, loaves, shreds, and/or individually-wrapped slices, for example. In various embodiments, at least one inclusion such as pepper chunks and/or flakes, flavorings, fruit pieces and other compatible inclusions are admixed with the shredded natural cheese and incorporated into the heated-treated cheese.

The invention also relates to a method for reducing sodium levels and increasing calcium levels in heat-treated cheese, the method comprising replacing from about 25 percent to about 100 percent of an emulsifying salt or combination of emulsifying salts intended for inclusion as an ingredient in a process cheese at a level of from about 0.25 percent to about 3.0 percent (w/w) with from about 0.25 percent to about 5.0 percent (w/w) of milk mineral. In various embodiments, the milk mineral is isolated from the milk of an animal in the family Bovidae. In some embodiments, the milk mineral is isolated from the milk of domestic dairy cattle. In various embodiments, the milk mineral can be replaced with, or combined with, at least one algal mineral composition comprising calcium, at least one inorganic calcium/phosphorus (e.g., phosphate) composition, or at least one combination thereof.

A method for replacing emulsifying salts in a heat-treated cheese, the method comprising adding milk mineral to at least one natural cheese used to produce a heat-treated cheese, wherein the milk mineral is added at from about 0.25 to about 5 weight percent of the heat-treated cheese as a substitute for a functionally equivalent amount of emulsifying salt. In various embodiments, the emulsifying salt is selected from the group consisting of monosodium phosphate, disodium phosphate, dipotassium phosphate, trisodium phosphate, sodium hexametaphosphate, sodium acid pyrophosphate, tetrasodium pyrophosphate, sodium aluminum phosphate, sodium citrate, potassium citrate, calcium citrate, sodium tartrate, sodium potassium tartrate, and combinations thereof.

The invention also relates to a method for producing a functional cheese, the method comprising adding milk mineral during any of the steps of coagulating, draining, salting, and ripening during natural cheese manufacture the milk mineral comprising from about 0.25 percent to about 5 percent w/w of the natural cheese product, thereby producing a functional cheese.

### BRIEF DESCRIPTION OF THE DRAWINGS

FIG. 1a is a photograph illustrating the limited stretch achieved with a process cheese made with emulsifying salts, and FIG. 1b is a photograph illustrating the increased stretch achieved with a heat-treated cheese made with milk mineral.

FIG. 2 is a photograph of packaged slices and a packaged block of functional cheese made by the addition of milk mineral to Colby Jack cheese curds, followed by extrusion processing.

FIG. 3 is a series of photographs illustrating the effect on stretch that can be achieved by varying the amount of milk mineral that is added when producing heat-treated cheese (1%, FIG. 3a; 1.5%, FIG. 3b, 2%, FIG. 3c).

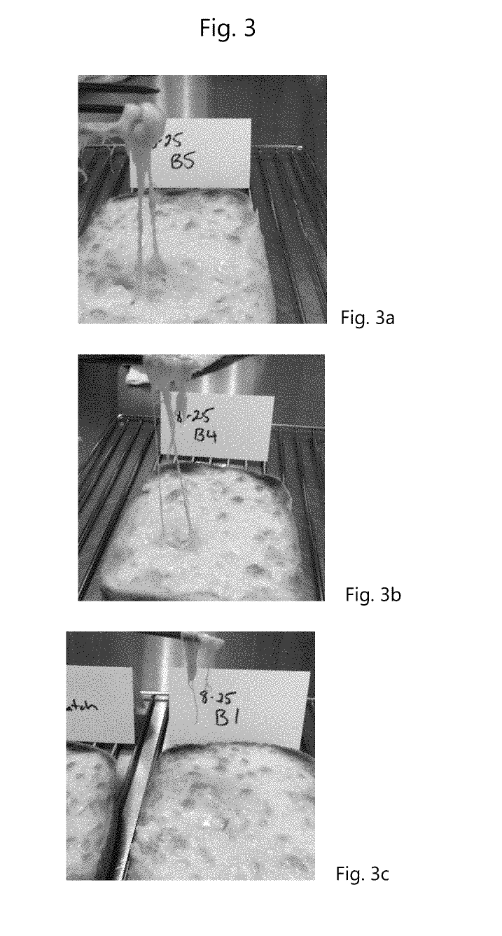

FIG. 4 is a photograph illustrating the use of heat-treated cheese made with milk mineral as part of a cheeseburger.

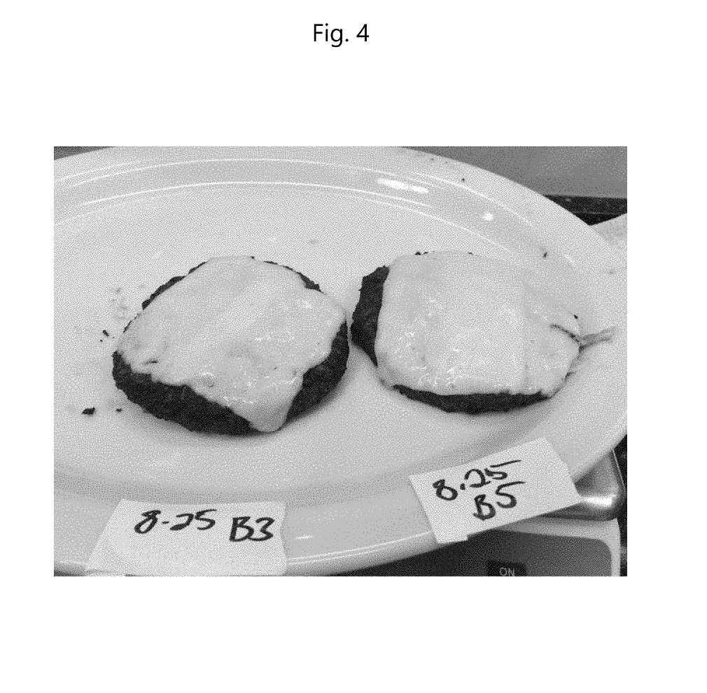

FIG. 5 is a series of photographs illustrating the melting and physical characteristics of various cheeses on burger patties. Top left to right: natural Cheddar, “young” process cheese, heat-treated cheese made by the method of the invention. Lower left to right: American pasteurized prepared cheese product, aged process cheese, aged heat-treated cheese made by the method of the invention.

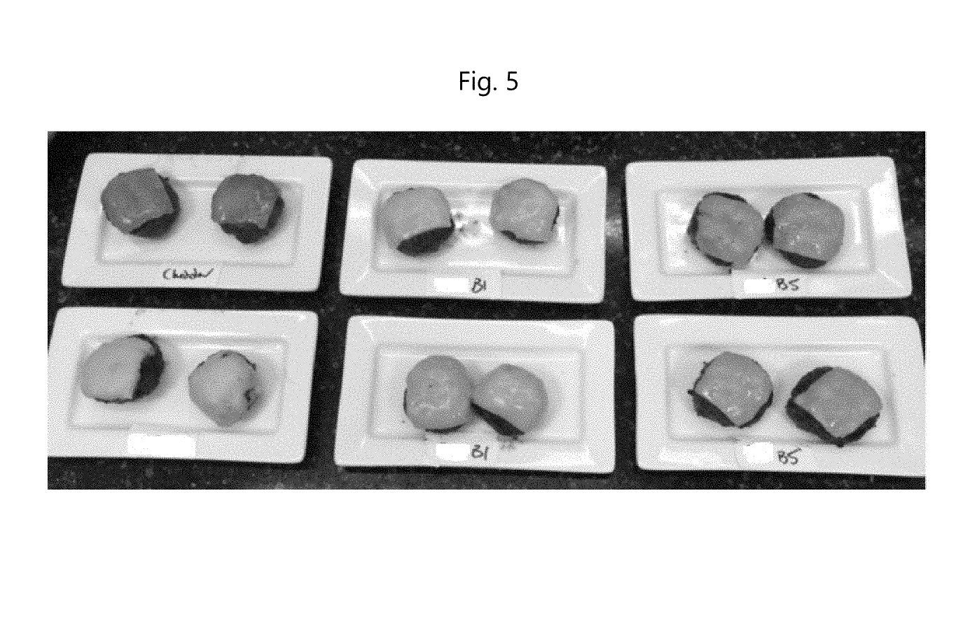

FIG. 6 is a photograph illustrating the comparison of stretch of heated low-moisture, part skim (LMPS) Mozzarella (left) to heat-treated cheese of the invention (1.5% milk mineral) on a pizza. The heat-treated cheese of the invention, although made of a mix of Cheddar cheeses, has good stretch, as illustrated in the side-by-side comparison with natural Mozzarella.

FIG. 7 is a photograph illustrating the comparison of stretch of a mix of two shredded Cheddar cheeses (left) and a heat-treated cheese made with those same two Cheddar cheeses and 1.5% milk mineral (right), after both are added to and baked on a pizza at 425 degrees Fahrenheit.

FIG. 8 is a photograph illustrating the comparison of stretch of a mix of two shredded Cheddar cheeses (left) and a heat-treated cheese made with those same two Cheddar cheeses and 2% milk mineral (right), after both are added to and baked on a pizza at 425 degrees Fahrenheit. As shown in the photograph, the addition of 2% milk mineral produces a cheese with good melting properties, but reduced stretch.

FIG. 9 is a graph of % w/w of free oil (lower numbers indicating stronger emulsification), and the meltability score (higher numbers indicating an increase in area, or “spreading”). TC=milk mineral, TCP=tricalcium phosphate, A=AlgaeCal®, PL=phospholipase, TSP=trisodium phosphate, and DSP=disodium phosphate. The first bar in each pair represents free oil and the second bar represents meltability.

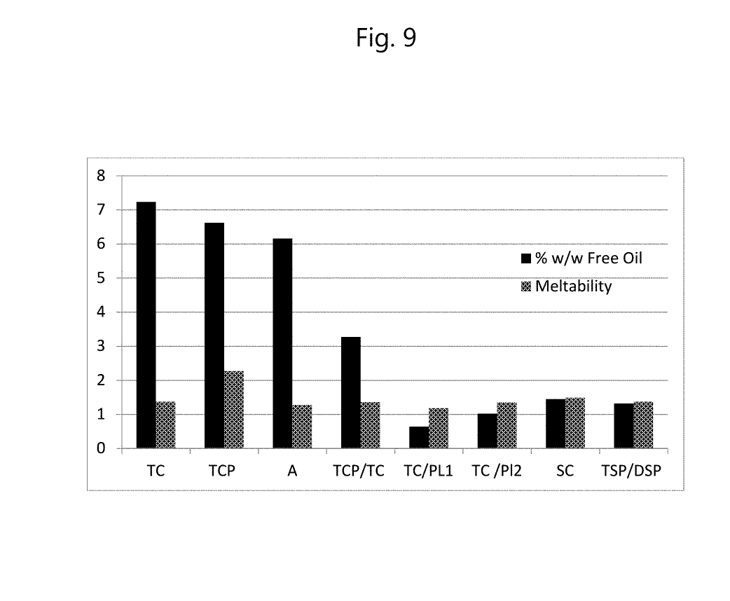

### DETAILED DESCRIPTION

The inventors have developed a method for reducing or eliminating the need for emulsifying salts in the manufacturing of heat-treated cheeses while producing heated-treated cheese products that can be lower in sodium than similar products made with emulsifying salts, yet maintain the desired stability and meltability of heated-treated cheese. Previously, Galpin et al. (WO2010/140905) disclosed a method for reducing or eliminating the need for emulsifying salts for making heat-treated cheese, but the method required removing a substantial amount of calcium from the starting material or intermediates in the process. In their disclosure, they stated that “unless the calcium content of the cheese . . . is significantly reduced, process cheese and related products cannot be made without emulsifying salts.” (Page 4, lines 4-6.) Fox et al. state that “[a]pplication of heat and mechanical shear to natural cheese in the absence of stabilisers usually results in a heterogeneous, gummy, pudding-like mass which oils-off extensively.” [This] “can be prevented by the addition of ESs [emulsifying salts], at a level of 1-3% (w/w) to the cheese blend prior to processing.” (Fox, P., et al. Fundamentals of Cheese Science, 2017, Springer Publishing, p. 601.) However, the inventors have discovered that heated cheese products, the types of cheeses referred to in the industry as “process” cheese, or “pasteurized process” cheeses, can very successfully be made without the use of emulsifying salts and without the step of calcium depletion. In fact, the method of the present invention uses calcium-containing compositions to produce heat-treated cheese. Since the term “process cheese” has a legal definition in the United States and many other countries, products made by the method of the invention will be referred to herein as “heat-treated” cheeses in order to minimize confusion and distinguish them from the “process cheese” to which emulsifying salts are added. Products made by the method of the invention contain significantly lower amounts of sodium than their counterparts made with sodium-containing emulsifying salts. Products made by the method of the invention also contain significantly higher amounts of calcium, making these products even more attractive as “calcium-rich foods.”

The invention disclosed herein will be described in terms of two major categories of cheeses: (1) “natural” cheeses, and (2) “process” cheeses. In the United States, “pasteurized process cheese” has a meaning that can be found in the United States Code of Federal Regulations (CFR), section 133.169(a)(1), which states that “[p]asteurized process cheese is the food prepared by comminuting and mixing, with the aid of heat, one or more cheeses of the same or two or more varieties, except cream cheese, neufchatel cheese, cottage cheese, low-fat cottage cheese, cottage cheese dry curd, cook cheese, hard grating cheese, semisoft part-skim cheese, part-skim spiced cheese, and skim milk cheese for manufacturing with an emulsifying agent prescribed by paragraph (c) of this section into a homogeneous plastic mass. One or more of the optional ingredients designated in paragraph (d) of this section may be used.” The emulsifying agent prescribed by paragraph (c) must be chosen from the list provided in 37 CFR 133.169(c): “one or any mixture of two or more of the following: [m]onosodium phosphate, disodium phosphate, dipotassium phosphate, trisodium phosphate, sodium metaphosphate (sodium hexametaphosphate), sodium acid pyrophosphate, tetrasodium pyrophosphate, sodium aluminum phosphate, sodium citrate, potassium citrate, calcium citrate, sodium tartrate, and sodium potassium tartrate, in such quantity that the weight of the solids of such emulsifying agent is not more than 3 percent of the weight of the pasteurized process cheese.”

“Natural cheese” is not specifically defined under 37 CFR 133, although the requirements for labeling specific cheeses are included in that section, but is understood in the industry to include cheeses that are made by a process that comprises four basic steps: coagulating, draining, salting, and ripening, as compared to processed cheese manufacture which incorporates extra steps such as cleaning, blending, and melting (as well as adding emulsifiers). Natural cheeses include familiar varieties such as Cheddar, Colby, Monterrey Jack, Provolone, Mozzarella, Gouda, Swiss, Havarti, etc. “Natural cheese,” as used herein, does not include cheeses that have been substantially calcium-depleted, such as by making them from calcium-depleted cheese milk which has been treated to replace calcium with sodium and/or potassium, for example.

“Pasteurized process cheese” and “process cheese” are often used interchangeably, as many process cheeses are also pasteurized. As used herein, the terms “heat-treated cheese” and “process cheese” will be used separately to denote a product comprising heat-treated cheese that is made without the use of emulsifying salt(s) (“heat-treated cheese”) and a product comprising heat-treated cheese that is made using emulsifying salts (“process cheese”). A third category of cheese will also be disclosed herein—“functional cheese”—which is a product produced by the addition of milk mineral during the process generally used to make natural cheese such as, for example, Cheddar, Mozzarella, Swiss, Monterrey Jack, Colby, Colby Jack, etc. The addition of milk mineral during this process provides a final product (“functional cheese”) that has increased functionalities such as, for example, smoother melting to provide less separation of caseins and oils, superior stretch (an advantage that is especially desirable in “pizza cheeses,” such as Mozzarella), etc. Historically, the addition of process cheese to pizza has been limited because of the lack of “stretch” and “stringiness” that customers have come to expect in pizzas and that would traditionally be found in Mozzarella or pizza cheese. A functional cheese that is subsequently heat-treated can provide desirable functionalities such as, for example, stretch and stringiness, and is an alternative choice to fully or partially replace Mozzarella or other “pizza cheeses.” A functional cheese produced by this method is suitable for consumer use and/or functional cheese can be provided to a process cheese producer to facilitate production of heat-treated or process cheese for applications such as cheeseburgers, pizza, and other applications where melt and stretch are critical for consumer acceptance. Using this technology, a functional heat-treated cheese can be created that would have desirable additional flavor(s) (using different varieties of cheese and various aged cheeses, for example) as well as similar stretch and functionality to that of a Mozzarella or pizza cheese.

The general method for making pasteurized process cheese is known to those of skill in the art and is described, for example, by Patrick Fox et al. in the 2^{nd} edition of Fundamentals of Cheese Science (©2017, Springer Publishing) at pages 596-599. One of the initial steps is reducing the size of the natural cheese product(s) from which the heat-treated cheese will be made. This is accomplished by the use of “curd breakers,” which break the cheese into smaller chunks, or by shredders, which shred the cheese. Therefore, where the term “shredded cheese” is used herein, it is intended to denote the pieces of cheese that comprise chunks, shreds, or other smaller pieces formed by mechanical size reduction of the blocks of natural cheese. At a next step, the shredded cheese is blended with other ingredients that the formulator intends to incorporate into the final heated cheese product—such as, for example, inclusions, flavorings, and/or emulsifying salts, if desired. Next, the blend is heated, with constant agitation until a “uniform molten consistency” is produced. The heating step can be performed, for example, by direct or indirect steam injection into a kettle-type cooker, producing temperatures of from about 75 to about 85 degrees Celsius. The heating/agitating step usually lasts from about 1 to about 5 minutes. Additional steps in the process may include homogenization, packaging, cooling, and storage of the resulting heat-treated cheese.

“Milk mineral,” also known as “dairy mineral,” as well as “whey minerals” is isolated by various means from the liquid milk permeate stream containing the mineral fraction, concentrated, and dried to provide a powder form. The term may also more broadly be used to describe the liquid fraction containing minerals from milk. Milk contains a distinctive mineral profile, and milk mineral therefore has a combination of particular minerals in about the same ratios at which they are found within the natural milk product. Milk mineral is therefore a composition comprising minerals isolated from milk which generally contains no added non-dairy chemicals or artificial ingredients, providing a “clean label” alternative to emulsifying salts (melting salts) for use in cheese processing. Commercially-available milk mineral contains varying amounts of protein, depending upon the target use for the milk mineral composition. Milk mineral is also available in, for example, high milk mineral whey protein concentrates, whey protein isolates, milk protein concentrates, and milk protein isolates. Minerals in milk mineral, in order from highest to lowest percentages, include calcium, phosphorus, sodium, magnesium, and potassium. For consumers who are interested in “clean label” products, heat-treated cheese made by the use of milk mineral should provide an attractive option. Milk mineral is commercially available from a variety of sources, including Glanbia Nutritionals, Inc., Arla Foods, Inc., and Fonterra. Mineral composition of two commercially-available milk mineral products produced by Glanbia Nutritionals, Inc. (Twin Falls, Id. USA) are listed in Table 1.

TABLE 1
Milk Mineral Composition

| Product | Calcium | Phosphorus | Sodium | Magnesium | Potassium |
|---|---|---|---|---|---|
| Name | (%) | (%) | (%) | (%) | (%) |
| Glanbia milk | 24.8 | 14 | 0.62 | 1.4 | 0.7 |
| mineral | | | | | |
| Optisol ® | 24.8 | 14.4 | 0.62 | 1.4 | 0.7 |
| 1200 | | | | | |

Mineral compositions containing significant amounts of calcium can also be isolated from plant sources, as some plants are known to be significant sources of calcium. Mineral compositions containing significant amounts of calcium can also be isolated from algae, some of those compositions being currently marketed under trade names such as “AlgaeCal®.” Those of skill in the art will also be aware that mineral compositions can be isolated from some microbiological sources such as bacteria, and that these compositions, which contain calcium in conjunction with other minerals such as, for example, phosphorus and magnesium, can be artificially reproduced by those of skill in the art by admixing inorganic minerals in the appropriate proportions. All of the foregoing are contemplated for use in the method of the invention. For example, inorganic calcium and phosphate (e.g., calcium phosphate) can be used at a level of from about 0.25% to about 3% w/w of heat-treated cheese to produce a heat-treated cheese without the addition of emulsifying salts. The phrase “a functional substitute for at least one emulsifying salt” means that the calcium composition provides the same or better stability and meltability as that provided by a functionally equivalent amount of at least one emulsifying salt. Calcium compositions can be admixed with at least one emulsifying salt, allowing the replacement of part of the emulsifying salt that would have been added, or they will preferably replace the emulsifying salts that would have been added had the calcium composition not been used to produce the desired effect in the heat-treated cheese.

The term “emulsifying salt” is used herein to mean a chemical compound selected from the group consisting of monosodium phosphate, disodium phosphate, dipotassium phosphate, trisodium phosphate, sodium metaphosphate (sodium hexametaphosphate), sodium acid pyrophosphate, tetrasodium pyrophosphate, sodium aluminum phosphate, sodium citrate, potassium citrate, calcium citrate, sodium tartrate, sodium potassium tartrate, and combinations thereof. “Emulsifying salt” may therefore denote a combination of more than one. “Emulsifying salt” can also denote types of salts, including, but not limited to the salts listed above, which can be used to promote melting in cheese—particularly those sodium- and/or potassium-containing salts.

The invention relates to a method for making a heat-treated cheese, the method comprising admixing with at least one natural cheese from about 0.25 percent to about 5 percent (w/w) of a milk mineral, melting the cheese by the addition of heat to produce a melted cheese, and transferring the melted cheese to a container to form the cheese as it cools, or run on traditional process cheese equipment to make slices, loaves, individually wrapped slices or other shapes and forms. In some embodiments, the milk mineral comprises from about 0.25 percent to about 3 percent (w/w) of the process-like cheese. In various embodiments, the milk mineral is isolated from the milk of domestic cattle. In various embodiments, the at least one cheese comprises one or more cheese selected from the group consisting of Cheddar, Colby Jack, Mozzarella, Gouda, Havarti, and other cheeses that have been included in process cheese manufacture. In various embodiments, the at least one natural cheese is shredded prior to the addition of the milk mineral. In various embodiments, at least one inclusion such as pepper chunks and/or flakes, colors, flavors, fruit pieces and other inclusions are admixed with the natural cheese and milk mineral. Typically, the invention would be most broadly used in the dairy industry, where cheeses are most often produced using milk from domestic dairy cattle but could apply to cheese from other animal sources such as sheep, goats, camels etc.

Briefly, milk mineral can be added to one or more natural cheese(s) such as Cheddar, Mozzarella, Swiss, Monterrey Jack, Colby, and/or Colby Jack, for example. By way of non-limiting example, this addition can be made by admixing the milk mineral into a composition comprising cheese curds (i.e., during the process used to make natural cheese), by admixing the milk mineral into a composition comprising shredded or otherwise comminuted pieces of aged cheese which are intended for use in the making of a heat-treated cheese by the usual steps performed for making process cheese, etc. It should be noted that aging provides time for cheese curds to knit to form a cohesive cheese consistency and continued aging leads to aged cheese with increase protein hydrolysis. Various aged cheese can be incorporated into the technology to vary the intensity of various functional attributes such as melt, stretch, stringiness, oiling off etc. Therefore, the functionalities of the functional cheeses and/or heat-treated cheeses that are produced by the method of the invention may be varied by those of skill in the art, as desired, by taking into account the age of cheese(s) used, the types of cheese used, and the level of milk mineral used to make heat-treated cheese. For example, the inventors have demonstrated that varying the amount of milk mineral utilized in manufacturing a heat-treated cheese for use on pizza can increase the amount of stringiness, or stretch in the resulting cheese. Generally, in their experiments with heated-treated cheese containing Cheddar or Colby Jack, lower amounts (about 1.5 percent milk mineral, rather than about 2 percent milk mineral, for example) have resulted in more stretch/stringiness. They also noted that the use of less aged cheese promoted stretch/stringiness in this type of cheese, as well. Therefore, the invention provides those of skill in the art with a method for manufacturing cheeses having specific properties that are targeted for the specific products on/in which the cheeses will be used. For example, heat-treated cheeses intended for use on pizza can have a stretchier, stringier consistency, while cheese intended for use on cheeseburgers, for example, can be formulated to have less stretch, but desirable melting properties to allow the cheese to evenly melt over the surface of, and onto the sides of, the meat patty.

The invention also relates to a method for reducing sodium levels and increasing calcium levels in heat-treated cheese, the method comprising replacing from about 25 percent to about 100 percent of an emulsifying salt or combination of emulsifying salts intended for inclusion as an ingredient in a process cheese at a level of from about 0.25 percent to about 3.0 percent (w/w) with from about 0.25 percent to about 5.0 percent (w/w) of milk mineral. In various embodiments, the milk mineral is isolated from the milk of an animal in the family Bovidae. In some embodiments, the milk mineral is isolated from the milk of domestic dairy cattle. Although the inventors have demonstrated that it is possible, and preferable, to totally replace emulsifying salts with milk mineral in the manufacture of a heated-treated process-like cheese product, there may be those in the industry who prefer to utilize the benefit of milk mineral addition while retaining the use of some of the emulsifying salt ingredient. The invention therefore includes embodiments of the method which involve replacing either all, or a fraction, of the emulsifying salt that would have, in the absence of the addition of the milk mineral replacement, been included among the ingredients for process cheese production.

The invention also relates to a method for replacing emulsifying salts in a process cheese, the method comprising adding milk mineral to at least one cheese used to produce a process cheese, wherein the milk mineral is added at from about 0.25 to about 5 weight percent of the process cheese in the absence of the addition of a functionally significant amount of an emulsifying salt. In various embodiments, the invention also relates to a method for making a heat-treated cheese using at least one plant mineral composition comprising calcium, at least one algal mineral composition comprising calcium, at least one bacterial mineral composition comprising calcium, and combinations thereof. The inventors have also demonstrated that inorganic minerals added to supply calcium, preferably in conjunction with another mineral which may be found in mineral compositions from natural sources such as mammalian milk, algal minerals, bacterial minerals, and/or plant minerals, such as, for example, magnesium, phosphorus, etc., provide the desired effect for producing a heat-treated and/or functional cheese.

The invention also relates to a method for producing a functional cheese, the method comprising adding milk mineral during natural cheese processing at a level of from about 0.25 percent to about 5 percent w/w of the natural cheese product, thereby producing a functional cheese. During the method for producing a natural cheese, the steps of coagulating, draining, salting, and ripening are employed. Milk mineral can be added during one or more of the steps—and would be particularly effective during the steps of coagulating and/or salting. Recrumbling of “green” cheese can be performed for various reasons, including, for example, to reform cheese that may not meet size and shape standards during block formation. Milk mineral can be added during this recrumbling/reformation process, as well, to provide a functional cheese. Process cheese manufacturers commonly use dry cream (powder), or non-fat dried milk (NFDM) powder added to cream, or a powdered coloring agent added to their products. Milk mineral can be admixed with any or all of these ingredients to facilitate its ease of addition during the cheese-making process.

Since emulsifying salts are not added to natural cheeses, the oils tend to separate from them when heat sufficient for melting is applied. This tends to limit their use in some applications. The present invention allows a cheese-producer to prepare cheeses from natural cheese while improving their physical properties using a fraction that has been isolated from natural milk. No commercial chemicals are required, yet the effect of adding this natural milk fraction—known in the industry as the “milk mineral fraction,” or just “milk mineral,” is similar to—if not superior to—the effect of adding emulsifying salts. In effect, this can also enable a cheese manufacturer to ultimately produce a heat-treated cheese product without some of the additional steps that would be required to produce process cheese with emulsifying salts.

Products made by the method of the invention can provide not only a lower-sodium alternative for process-like cheeses, but these same products provide a higher-calcium alternative for both process-like (heat-treated) cheeses and natural cheeses (functional cheese), with the added advantage that the calcium is provided in a food, and in the natural ratio of minerals found in milk. Recently, researchers reported in the Journal of the American Heart Association the results of a 10-year long-term study comparing the effects of calcium intake via supplements vs calcium intake via food, and they found that there was an increased incidence of coronary artery calcification in individuals who ingested their calcium via supplement. That effect was not seen in individuals who ingested their calcium by eating calcium-rich foods. They also reported that they found a “protective relationship between total calcium intake and incident coronary atherosclerosis,” but based on their study they recommended that calcium-rich foods be the preferred source of calcium in the diet. (Anderson, J. J. B. et al., Calcium Intake from Diet and Supplements and the Risk of Coronary Artery Calcification and its Progression among Older Adults: 10-Year Follow-up of the Multi-Ethnic Study of Atherosclerosis (MESA), J Am Heart Assoc. 2016; 5:e003815.) Also, according to the United States Department of Agriculture, in 2012 the school lunch program provided meals to approximately 31 million students on a daily basis. It has been a goal of the program to provide healthy foods, and cheese made by the method of the present invention meet two important goals in child and adolescent nutrition: (1) reducing sodium consumption, and (2) increasing consumption of bone-building calcium. The inventors have demonstrated that this can be done without the addition of non-dairy ingredients, or chemicals, to alter the structure of the cheese to produce desirable properties that make certain foods—such as pizza, cheeseburgers, and macaroni and cheese—that children and adolescents are more prone to eat, and which are served at least weekly in most school cafeterias.

Products made by the method of the invention can be used in many of the same ways that process cheeses are used, such as, for example, to produce sauces, dips, casseroles, macaroni and cheese, and other food items. The method of the invention can also expand the uses of certain cheese products, by giving those cheese products better melting properties, improved stretchy, stringy, properties, etc. For example, although we refer to cheese “melting,” cheese actually does not undergo a melting process. Instead, it undergoes a “glass transition.” At or its glass transition temperature, the cheese has a firm, or “glassy” state. Above the transition temperature, it turns into a more “rubbery” solid that flows easily. The elasticity, free oil, and transition temperature of a cheese influence its color uniformity in applications such as use on pizza (Ma, X. et al., Quantification of Pizza Baking Properties of Different Cheeses, and Their Correlation with Cheese Functionality, J. of Food Sci. (August 2014) 79(8): E1528-E1534).

Functional cheeses made by the method of the invention can “self-emulsify” when heated. If they are intended for use in heat-treated or process cheese manufacture, they readily form emulsions when heated and mixed, without requiring the addition of emulsifying salts. Heated-treated and functional cheeses made by the method of the invention provide an attractive alternative to a variety of cheeses for use on food items such as, for example, hamburgers (cheeseburgers) and pizza. Cheeseburgers are typically prepared with at least one slice of a cheese that melts to cover the upper surface and sides of the burger, preferably without producing an oily, slick surface on the cheese. Heat-treated and/or functional cheeses made by the method of the invention achieve this desired result. For other products such as pizza, deep-fried cheese sticks, etc., consumers like the “stretch” of the cheese—which should be sufficient to draw the cheese out as a pizza slice is being removed from the pizza or a bite is taken from the deep-fried cheese sticks, while not being so stretchy that the cheese is hard to break away from the pizza, the pizza slice, or the remaining portion of cheese stick, for example. These various functionalities can be produced—and improved—using the method of the invention, particularly when one of skill in the art utilizes three main parameters to produce cheeses having the desired functionalities, these parameters being the age of the cheese(s) used, the types of cheese(s) used, and the level of milk mineral added to the cheese(s).

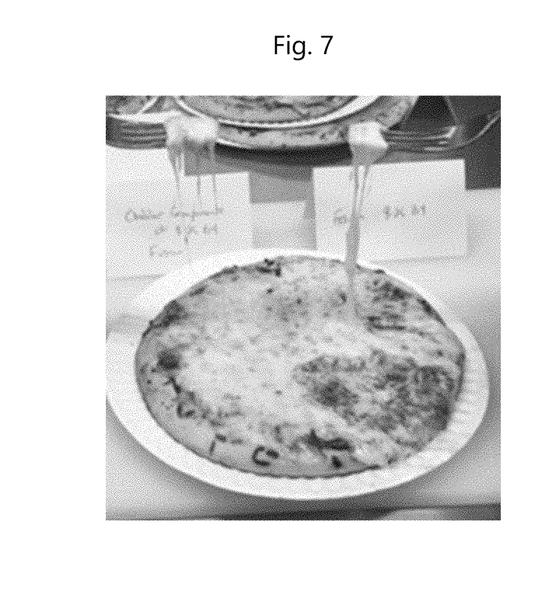

The melt and stretch properties of cheese are based on the number of interactions between casein molecules. The fewer the interactions, the greater the melt. Stretch requires an intact, interconnected casein network and is lost as the interactions between casein molecules, or aggregates of casein molecules, decrease. Stretch is the result of casein-casein interactions that are broken easily but also readily reform at different locations in the casein network. While not being bound by theory, observations made by the inventors indicate that adding lower levels of milk mineral maintains the interconnected casein network, producing a cheese with stretch. Increasing the amount of milk mineral increases the melt properties of the cheese produced thereby. This presents cheesemakers with an opportunity to produce cheeses, other than just pasta filata, that can stretch when melted, opening up the option of adding a variety of other cheeses to the mix of cheese that can be used on pizza, for example, without losing the stretchiness of the cheese that consumers expect and appreciate. For example, Cheddar cheeses were mixed and heating with the addition of milk mineral at 1% w/w to produce a stretchy heat-treated cheese, as shown in FIG. 7 (natural Cheddar on the left, heat-treated Cheddar on the right). The pizza industry is always offering new options and flavors for pizza such as Cheddar or Mozzarella cheese within the crust, butter, garlic, bacon, and other food products added into or on the rim of the crust, etc. The present invention offers the option of using a variety of other cheeses which can be used to produce heat-treated cheeses by the method of the invention, these heat-treated cheeses not only having the flavor of the natural cheeses from which they are produced, but also having the stretchy, stringy properties that are desirable in a cheese for use on pizza.

According to a 2015 online article in Food Business News, “[t]he relationship cheese has with salt is more than flavor. It is complicated, as cheese needs salt for functionality. During the manufacture of natural cheese, salt is added to the curd once the desired pH is attained. This helps control fermentation and proteolysis by regulating starter cultures and enzymes. Salt also lowers the water activity of cheese, which prevents the growth of undesirable microorganisms. Without added salt, natural cheese would have an unacceptable soft body and very short shelf life due to undesirable microbial growth and enzymatic activity. It also would be bitter and bland.” (Berry, D., Making salty cheese with less sodium, Food Business News, Jun. 16, 2015 (http://www.foodbusinessnews.net/articles/news_home/Supplier-Innovations/2015/06/Making_salty_cheese_with_less.aspx?ID=%7B53F14A3C-185A-4546-9E8C-F5BBB761202D % 7D&cck=1).) Alternatives have been explored, but thus far those alternatives do not provide the taste and functionality advantages provided by the method of the present invention. For example, potassium chloride provides an option, but its salty flavor is not as immediate as that of sodium chloride, and it has a bitter aftertaste. To reduce that bitter aftertaste, use of metallic blockers has been suggested. Potassium-based emulsifying salts provide a functional alternative to sodium-based emulsifying salts, but their use has been limited because of the bitter aftertaste that is associated with them. Whey permeate and milk permeate have also been suggested as a sodium alternative. These contain mostly lactose (often about 85%), minerals, sodium chloride, potassium chloride, lactic acid, citric acid, hippuric acid, uric acid, orotic acid, and urea. Frankowski et al. demonstrated that the salty taste provided by permeate is primarily due to its sodium chloride, potassium chloride, lactic acid, and orotic acid. (Frankowski, K. M. et al. The Role of Sodium in the Salty Taste of Permeate, J. Dairy Sci. (2014) 97:5356-5370). Milk mineral, on the other hand, contains primarily calcium and phosphorus, as well as smaller amounts of magnesium, potassium, sodium, chloride, and iron.

Process cheese manufacture involves a process known as “calcium sequestration.” This involves the exchange of calcium (Ca²⁺) of the para-casein for the sodium ion of the emulsifying salt. Replacing calcium with sodium as the counterion to the negatively-charged casein increases the protein hydration and alters the textural properties of the cheese. (Kilcast, D. and Angus, F., eds. Reducing Salt in Foods: Practical Strategies, Woodhead Publishing Ltd. (England)/CRC Press LLC (U.S.), ©2007, page 329 (section 16.4.3)). Therefore, based on current knowledge about the chemistry of process cheese manufacture, it would appear to be counter-intuitive to use a product that contains primarily calcium to achieve a similar effect to that obtained by calcium sequestration. However, the inventors have demonstrated that mineral compositions comprising functionally significant amounts of calcium do, indeed, provide heat-treated cheese products having many of the same desirable characteristics of process cheese, as well as some other desirable characteristics that have not previously been associated with process cheeses (e.g., stringiness and stretchiness).

Furthermore, the inventors have also determined that minerals of similar composition (i.e., calcium and/or phosphate, the mix comprising calcium and phosphate at a ratio of from about 4:1 to about 1:1) obtained from other sources such as, for example, inorganic minerals (e.g., tricalcium phosphate, dicalcium phosphate), may be used either to replace, or in conjunction with, milk minerals to produce products as described herein. Such a calcium source will preferably have a calcium content of up to about 50%. Given the information disclosed herein, those of skill in the art may modify the calcium-containing composition to optimize the effect, particularly as it may relate to the different cheeses which may be used to produce heat-treated cheese and/or functional cheese.

In U.S. Pat. No. 6,551,635 (22 Apr. 2003), Nielsen discloses the use of phospholipase to produce cheese, wherein the phospholipase is added to treat the cheese milk or is added as cheese is produced from the cheese milk. Phospholipase is known in the industry to increase cheese yield by improving fat and moisture retention in the curd (Karahan, L. E. and M. S. Akin, Phospholipase Applications in Cheese Production, J. Food Sci. 7 (2017) 312-315). Nielsen also suggests that this cheese may be used to produce processed cheese using emulsifying salts. The inventors added phospholipase to the cheese milk from which some of the cheese used in their experiments was made. They utilized phospholipase at two levels, one higher than the other, to further investigate its effects. They discovered that adding a calcium mineral composition to shredded phospholipase-treated cheese milk decreased the amount of free oils in the final heat-treated cheese product, without significantly impacting its meltability. The term “natural cheese” may therefore also encompass at least one cheese that has been produced by adding at least one phospholipase to the cheese milk before or during production of the natural cheese.

The invention also includes products made by the method of the invention. These products can have improved functionality and increased calcium as compared to their counterparts prepared without the use of a calcium mineral composition such as, for example, milk mineral. Heat-treated cheese products prepared by the method of the invention provide the additional advantage of reduced sodium content.

The invention has been described as “comprising” certain steps and ingredients, which those of skill in the art may also “consist of” or “consist essentially of” those steps and/or ingredients. Therefore, where the term “comprising” is used and the invention is intended to be more narrowly defined, the terms “consisting of” or “consisting essentially of” may also be used to describe the invention. The invention may also be further described by means of the following non-limiting examples.

### Examples

### Heat-Treated Cheese Production

Two lots of colored Cheddar cheese (#1936206401 and 105169301, each about 35% fat and about 36-37 percent moisture) were shredded using the shredder attachment for a Globe SP10 stand mixer. The shredded cheese was divided into three portions. One-third of the shredded cheese was added to the cooker (Blentech Cheezetherm Model CC-0010, using the indirect steam option) along with all the butter, then mixed. Shredded cheese was again added (⅓+⅓), then mixed, with a 2-minute mixing time after each addition. Water and either trisodium phosphate/disodium phosphate or milk mineral (Optisol® 1200, Glanbia Nutritionals®, Inc.) were added and mixed into the cheese/butter mixture. The mixed ingredients were then heated to 175 degrees Fahrenheit, then placed into a lined box to form the process cheese as it cooled.

Ingredient amounts, expressed as a weight percentage, are shown in Tables 2 and 3 below, for two separate sets (5 batches each) of process cheese prepared on different dates.

TABLE 2
Process Cheese Ingredients

| | Batch 1 | Batch 2 | Batch 3 | Batch 4 | Batch 5 |
|---|---|---|---|---|---|
| Mild Cheese (2-3 | 68.56 | 68.56 | 68.56 | 68.56 | 68.56 |
| months) | | | | | |
| Aged Cheese (3+ | 17.14 | 17.14 | 17.14 | 17.14 | 17.14 |
| months) | | | | | |
| Unsalted Butter | 6.05 | 6.03 | 6.03 | 6.03 | 6.03 |
| Water | 6.25 | 6.27 | 6.27 | 6.27 | 6.27 |
| Trisodium Phosphate | 0.67 | 0.50 | 0.34 | 0.17 | 0.00 |
| Disodium Phosphate | 1.33 | 1.00 | 0.67 | 0.33 | 0.00 |
| Optisol ® 1200 | 0.00 | 0.50 | 1.00 | 1.50 | 2.00 |
| Total | 100.00 | 100.00 | 100.00 | 100.00 | 100.00 |

TABLE 3
Process Cheese Ingredients

| | Batch 1 | Batch 2 | Batch 3 | Batch 4 | Batch 5 |
|---|---|---|---|---|---|
| Mild Cheese (2-3 | 34.28 | 34.28 | 34.28 | 34.28 | 34.28 |
| months) | | | | | |
| Aged Cheese (3+ | 51.42 | 51.42 | 51.42 | 51.42 | 51.42 |
| months) | | | | | |
| Unsalted Butter | 6.05 | 6.03 | 6.03 | 6.03 | 6.03 |
| Water | 6.25 | 6.27 | 6.27 | 6.27 | 6.27 |
| Trisodium Phosphate | 0.67 | 0.50 | 0.34 | 0.17 | 0.00 |
| Disodium Phosphate | 1.33 | 1.00 | 0.67 | 0.33 | 0.00 |
| Optisol ® 1200 | 0.00 | 0.50 | 1.00 | 1.50 | 2.00 |
| Total | 100.00 | 100.00 | 100.00 | 100.00 | 100.00 |

Batches were analyzed for composition, and results are shown in Table 4 below. Calcium levels were approximately 75% higher in the pasteurized cheese (i.e., the “process” cheese to which milk mineral had been added) than in the process cheese (to which emulsifying salts had been added). Sodium levels were roughly cut in half by the replacement of emulsifying salts with milk mineral.

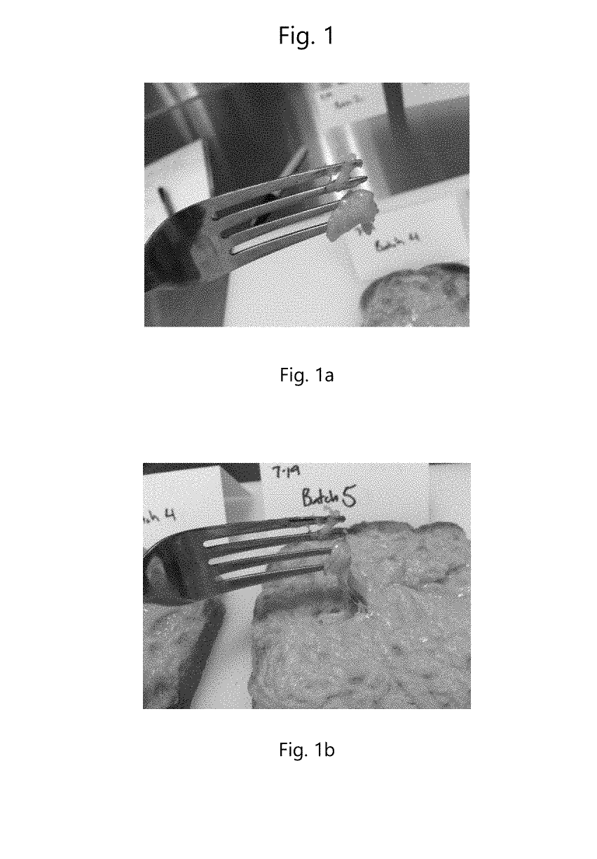

FIG. 1 shows a comparison of the stretch produced in the heat-treated cheese by replacing the emulsifying salt(s) with milk mineral. Addition of milk minerals produced a product with increased stretch.

TABLE 4
Analysis of Process Cheese (Emulsifying Salts Added)
vs. Heat-Treated Cheese (Milk Mineral Added)

| | Process | Pasteurized | |
|---|---|---|---|
| Analysis | Cheese | Cheese | Units |
| Ash | 4.78 | 4.79 | /100 g |
| Calcium | 608.00 | 1070.00 | mg/100 g |
| Calories | 373.80 | 381.20 | /100 g |
| Total Carbohydrate | 4.20 | 4.20 | /100 g |
| Cholesterol | 103.00 | 111.00 | mg/100 g |
| Iron | <0.10 | <0.10 | mg/100 g |
| Moisture | 40.24 | 39.11 | /100 g |
| Potassium | 66.70 | 85.90 | mg/100 g |
| Protein | 20.00 | 20.45 | /100 g |
| Saturated Fat | 20.14 | 20.56 | /gram |
| Sodium | 1260.00 | 634.00 | mg/100 g |
| Sugars | 1.12 | 1.27 | /100 g |
| Total Fat | 30.78 | 31.40 | /gram |
| Trans Fat | 1.00 | 1.02 | /100 g |
| Vitamin D | 3.000 | 4.000 | mcg/100 g |

### Preparation of Functional Cheese

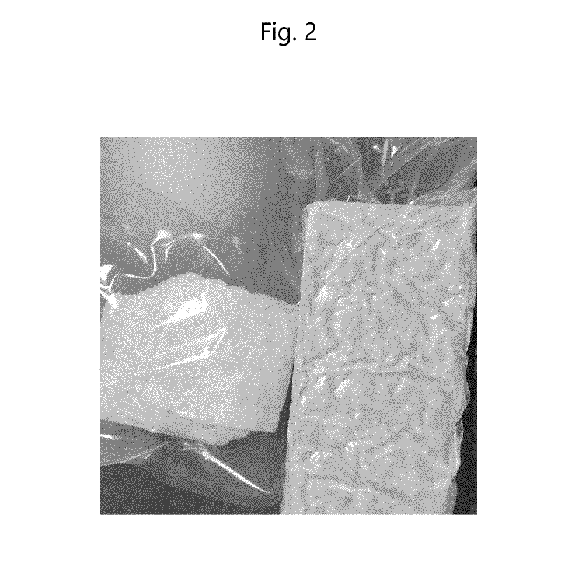

Colby Jack cheese curds produced at Glanbia Nutritionals, Inc. (Twin Falls, Id. USA) were mixed with 2 percent Optisol® 1200 and processed by extrusion technology described in US20160205962A1 (Geslison et al.). After a 1-month aging period, the cheese was sliced. Slices were less well-formed at that stage than slices produced from aged Cheddar or another aged natural cheese, for example, but the slices of functional cheese would be suitable for uses where melting of the slice is important. Also, blocks and/or slices of this functional cheese, particularly since curd knit is somewhat less tight than it is with aged natural cheese, represent an attractive product to be provided to cheese manufacturers for production of a heat-treated cheese product. FIG. 2 is a photograph of a package of cheese slices (left) and a packaged block of cheese (right) produced by the method.

### Preparation of Heat-Treated Cheese for Pizza

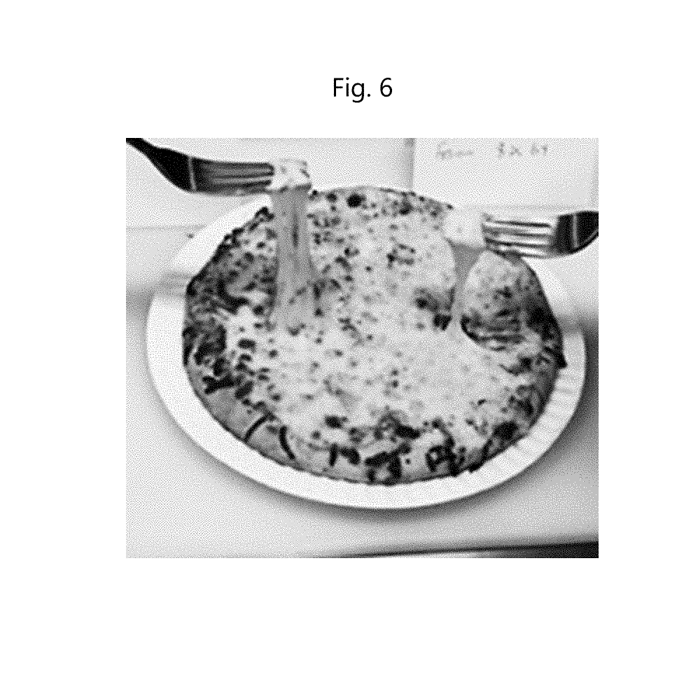

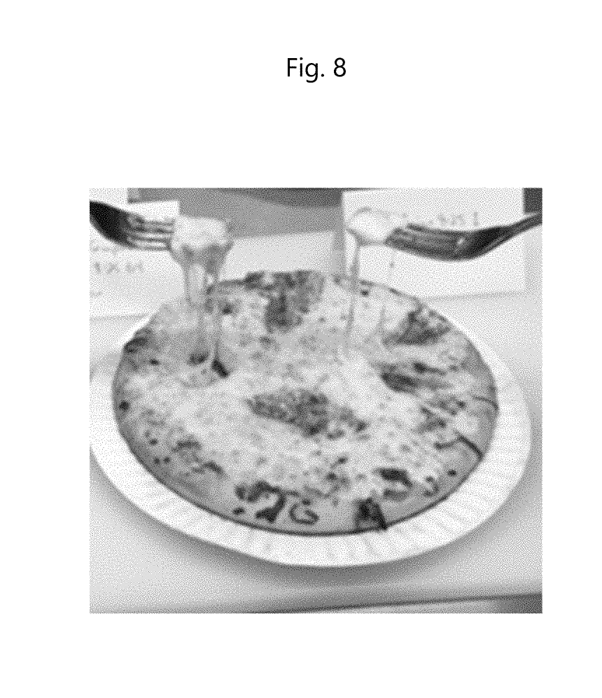

Cheddar cheeses produced at Glanbia Nutritionals®, Twin Falls, Id. US, and Galbani® low-moisture part skim (LMPS) Mozzarella cheese were shredded using a hand shredder. Pizzas were cooked using a Lincoln 2802731e Air Impingement Oven with a belt time of 17.5 minutes at a temperature of 425 degrees Fahrenheit. A 142 gram Boboli® mini original pizza crust was used with 50 grams of Boboli® pizza sauce. Each pizza contained a total of 100 grams of cheese, divided into two sides with 50 grams of each of two cheeses to be compared on each side (e.g., 50 g Mozzarella/50 g heat-treated cheese, etc.) The composition of the heat-treated cheeses tested is shown in Table 5, with results illustrated by the photographs of FIGS. 6-8. In these experiments, heat-treated cheese to which 1.5% milk mineral had been added was compared with heat-treated cheese to which 2% milk mineral had been added. Stretch was improved by the addition of 1.5% milk mineral.

TABLE 5
Percentage Composition - Cheese for Pizza

| | Prebatch | Batch 1 | Batch 2 | Batch 3 | Batch 4 | Batch 5 |
|---|---|---|---|---|---|---|
| Mild Cheese (2-3 months) | 34.28 | 34.28 | 34.28 | 34.28 | 34.28 | 34.28 |
| Aged Cheese (3+ months) | 51.42 | 51.42 | 50.42 | 49.42 | 51.92 | 52.42 |
| Unsalted Butter | 6.03 | 6.03 | 6.03 | 6.03 | 6.03 | 6.03 |
| Water | 6.27 | 6.27 | 6.27 | 6.27 | 6.27 | 6.27 |
| Optisol ® 1200 | 2.00 | 2.00 | 3.00 | 4.00 | 1.50 | 1.00 |
| Total | 100.00 | 100.00 | 100.00 | 100.00 | 100.00 | 100.00 |

Heat-Treated Cheese Production with Inorganic Mineral Sources

All 3 cheeses were shredded prior to cook using an Urschel cheese shredder. The Reduced Fat Cheddar and Regular Cheddar shreds were added to the cooker (Blentech Cheezetherm Model CC-0010) and mixed at 150 rpm for 30 seconds. Next, tricalcium phosphate (TCP), water, dry cream, EM Cheddar Cheese 3707P, salt, and A/P-855-OSS were added to the Process Cooker and the entire mixture was mixed and continued to heat to 175° F. at 150 rpm. As soon as the final temperature was reached, the product was discharged into a wax lined fiber box to achieve the final loaf form. Ingredients are listed in Table 7.

TCP was added to the heat-treated cheese in the same amount that milk mineral would typically be added (1.75%) to observe the effects of an inorganic mineral source as a substitute for milk mineral. Emulsification was as effective as that produced in heat-treated cheese containing milk mineral (Glanbia Nutritionals®, Inc.), and melt was less restricted. Heat-treated cheese was also made using Dicalcium Phosphate Anhydrous (DCPA) and Dicalcium Phosphate Dihydrate (DCPD) at 1.75% as a substitute for TCP. Similar results were observed with these inorganic mineral sources. Based on these observations, inorganic mineral sources can be added at a rate of 0.25% to 3% (w/w) of heat-treated cheese.

TABLE 6
Comparisons of Heat-treated cheese using Glanbia
Milk Mineral and Other Calcium Sources

| | Average Free Oil | Average |
|---|---|---|
| Cheese Type | (% w/w of cheese) | Meltability |
| Glanbia ® milk mineral only | 7.23 | 1.37 |
| TCP only | 6.62 | 1.59 |
| AlgaeCal ® only | 6.16 | 1.28 |
| TCP and Glanbia ® milk mineral | 3.27 | 1.36 |
| (1:1) | | |

TABLE 7

| | | Lot | % of |
|---|---|---|---|
| Ingredient | Manufacturer | Number | Total |
| Reduced Fat Cheddar | Glanbia Nutritionals ® | 2017R | 17.20% |
| (<60 days) | | | |
| Aged Cheddar | Glanbia Nutritionals ® | 04271 | 33.00% |
| (>90 days) | | | |
| Reg Cheddar | Glanbia Nutritionals ® | 22071 | 29.00% |
| (<60 days) | | | |
| Tricalcium Phosphate | Prayon | A047509 | 1.75% |
| (TCP) | | | |
| Water | Municipal | n/a | 11.50% |
| Dry Cream | Bluegrass Dairy | 03162017 | 6.98% |
| Enzyme Modified | First Choice | Exp01/2018 | 0.12% |
| Cheddar 3707P | Ingredients ® | | |
| Salt | Compass Mineral | 082916LD | 0.40% |
| A/P-855-OSS (annatto/ | CHR. Hansen ® | 125369 | 0.05% |
| paprika color) | | | |

### Heat-Treated Cheese Production Using Algae Mineral Source

All 3 cheeses were shredded prior to cook using the Urschel cheese shredder. The Reduced Fat Cheddar and Regular Cheddar shreds were added to the cooker (Blentech Cheezetherm Model CC-0010) and mixed at 150 rpm for 30 seconds. Next, AlgaeCal®, water, dry cream, EM Cheddar Cheese 3707P, salt, and A/P-855-OSS were added to the Process Cooker and the entire mixture was mixed and continued to heat to 175° F. at 150 rpm. As soon as the final temperature was reached, the product was discharged into a wax lined fiber box to achieve the final loaf form. Ingredients are listed in Table 8.

TABLE 8

| | | Lot | % of |
|---|---|---|---|
| Ingredient | Manufacturer | Number | Total |
| Reduced Fat Cheddar | Glanbia Nutritionals ® | 2017R | 17.20% |
| (<60 days) | | | |
| Aged Cheddar | Glanbia Nutritionals ® | 4271080 | 33.00% |
| (>90 days) | | | |
| Reg Cheddar | Glanbia Nutritionals ® | 220R | 29.00% |
| (<60 days) | | | |
| AlgaeCal ® | AlgaeCal ® | 10 | 1.75% |
| Water | Municipal | n/a | 11.50% |
| Dry Cream | Bluegrass Dairy | 03162017 | 6.98% |
| Enzyme Modified | First Choice | Exp01/2018 | 0.12% |
| Cheddar 3707P | Ingredients ® | | |
| Salt | Compass Minerals | 082616LD | 0.40% |
| A/P-855-OSS (annatto/ | CHR. Hansen ® | 125369 | 0.05% |
| paprika color) | | | |

### Heat-Treated Cheese Production Using Inorganic Mineral Sources and Milk Minerals

Both cheeses were shredded prior to cook using the Urschel cheese shredder. The Monterey Jack shreds were added to the cooker (Blentech Cheezetherm Model CC-0010) and mixed at 150 rpm for 30 seconds. Next, Glanbia® milk mineral, TCP, water, dry cream, EM Cheddar Cheese 3707P, salt, and A/P-855-OSS were added to the process cooker and the entire mixture was mixed and continued to heat to 175° F. at 150 rpm. As soon as the final temperature was reached, the product was discharged into a wax lined fiber box to achieve the final loaf form. Ingredients are listed in Table 9.

Heat treated cheese including inorganic mineral sources in conjunction with milk minerals produced excellent emulsification. TCP was added to the heat-treated cheese in addition to milk mineral (0.88% TCP, 0.88% Glanbia® milk mineral). Ratios of milk mineral to non-milk mineral range from 1:3 to 3:1. Non-milk mineral usage can range from 0.31% to 0.94% (w/w) of heat-treated cheese.

TABLE 9

| | | Lot | % of |
|---|---|---|---|
| Ingredient | Manufacturer | Number | Total |
| Aged Cheddar | Glanbia Nutritionals ® | 4271080 | 33.00% |
| (>90 days) | | | |
| Monterey Jack | Glanbia Nutritionals ® | 21972 | 47.20% |
| (<60 days) | | | |
| Glanbia milk minerals | Glanbia Nutritionals ® | 0767345 | 0.88% |
| TCP | Prayon | A047509 | 0.88% |
| Water | Municipal | n/a | 10.50% |
| Dry Cream | Bluegrass Dairy | 03162017 | 6.98% |
| Enzyme Modified | First Choice | Exp01/2018 | 0.12% |
| Cheddar 3707P | Ingredients ® | | |
| Salt | Compass Minerals | 082916LD | 0.40% |
| A/P-855-OSS (annatto/ | CHR. Hansen ® | 125369 | 0.05% |
| paprika color) | | | |

Heat-Treated Cheese Made with Phospholipase and Milk Mineral

Heat-treated cheese was made according to the method described above. To investigate the effect of the combination of milk mineral and phospholipase on the final product, milk mineral or a combination of milk mineral and phospholipase (YieldMax®PL, CHR Hansen®) were added to the cheese. Phospholipase was added at two concentrations (designated below as “lower” and “higher”) to further evaluate the possible effect on the final product. Phospholipase was incorporated into the cheese milk from which the cheese was made prior to heat treatment in this trial. As shown in Table 10, the amount of free oil in the heat-treated cheese was decreased by using the combination of milk mineral and phospholipase, while the meltability—a signature property of process cheese—was not significantly affected.

TABLE 10
Comparisons of Heat-treated Cheese Using Glanbia ® Milk Mineral
and Phospholipase (YieldMax ® PL) vs Milk Mineral Only

| | Free Oil | |
|---|---|---|
| Ingredients Added | (% w/w of cheese) | Meltability |
| Glanbia ® Milk Mineral | 13.62 | 1.37 |
| | 14.06 | 1.42 |
| Glanbia ® Milk Mineral + | 3.63 | 1.37 |
| YieldMax ® (lower) | 3.03 | 1.25 |
| Glanbia ® Milk Mineral + | 1.43 | 1.44 |
| YieldMax ® (higher) | 3.36 | 1.44 |
| Glanbia ® Milk Mineral | 10.26 | 1.37 |
| | 6.28 | 1.42 |
| Glanbia ® Milk Mineral + | 2.75 | 1.18 |
| YieldMax ® (lower) | 3.7 | 1.18 |
| Glanbia ® Milk Mineral + | 3.31 | 1.27 |
| YieldMax ® (higher) | 3.61 | 1.27 |

What is claimed is:

1. A method for making a heat-treated cheese, the method comprising admixing with at least one shredded natural cheese a composition comprising at least one inorganic calcium composition, wherein the calcium composition provides a functional substitute for at least one emulsifying salt, and heat-treating the shredded natural cheese and at least one inorganic calcium composition to produce a heat-treated cheese.

2. The method of claim 1 wherein the calcium composition comprises milk mineral.

3. The method of claim 2 wherein the milk mineral comprises from about 0.25 percent to about 3 percent (w/w) of the heat-treated cheese.

4. The method of claim 1 wherein the at least one natural cheese is shredded prior to the addition of the calcium composition.

5. The method of claim 1 wherein the at least one natural cheese is shredded after the addition of the calcium composition.

6. The method of claim 1 wherein the natural cheese is a cheese produced by adding at least one phospholipase to treat the cheese milk or adding at least one phospholipase as cheese is produced from the cheese milk.

7. A method for making a heat-treated cheese, the method comprising admixing with at least one shredded natural cheese a composition comprising calcium and phosphate, the ratio of calcium to phosphate in the composition being from about 4:1 to about 1:1, and heating the shredded cheese and calcium composition to produce a heat-treated cheese.

8. The method of claim 7 wherein the composition can be selected from the group consisting of milk mineral, inorganic calcium, inorganic phosphorus, and combinations thereof.

9. The method of claim 7 wherein the milk mineral is isolated from bovine milk.

10. The method of claim 7 wherein the natural cheese is a cheese produced by adding at least one phospholipase to treat the cheese milk or adding at least one phospholipase as cheese is produced from the cheese milk.

11. A method for making a heat-treated cheese, the method comprising admixing with at least one natural cheese from about 0.25 percent to about 5 percent (w/w) of a composition selected from the group consisting of milk mineral, algal mineral, a composition comprising inorganic calcium and phosphorus, and combinations thereof, melting the cheese by the addition of heat to produce a melted cheese, and transferring the melted cheese to a device for forming and cooling the cheese.

12. The method of claim 11 wherein the milk mineral comprises from about 0.25 percent to about 3 percent (w/w) of the heat-treated cheese.

13. The method of claim 11 wherein the milk mineral is isolated from the milk of domestic cattle.

14. The method of claim 11 wherein the at least one natural cheese is selected from the group consisting of Cheddar, Mozzarella, Colby, Monterrey Jack, Colby Jack, and combinations thereof.

15. The method of claim 11 wherein the natural cheese is a cheese produced by adding at least one phospholipase to treat the cheese milk or adding at least one phospholipase as cheese is produced from the cheese milk.

16. A method for reducing sodium levels and increasing calcium levels in heat-treated cheese, the method comprising replacing from about 25 percent to about 100 percent of at least one emulsifying salt selected from the group consisting of monosodium phosphate, disodium phosphate, trisodium phosphate, sodium hexametaphosphate, sodium acid pyrophosphate, tetrasodium pyrophosphate, sodium aluminum phosphate, sodium citrate, sodium tartrate, sodium potassium tartrate, and combinations thereof, which are intended for inclusion as an ingredient in a process cheese at a level of from about 0.25 percent to about 3.0 percent (w/w), with from about 0.25 percent to about 5.0 percent (w/w) of a composition comprising milk mineral, algal mineral, plant mineral, inorganic calcium and phosphorus, and combinations thereof.

17. The method of claim 16 wherein the milk mineral is isolated from the milk of an animal in the family Bovidae.

18. The method of claim 16 wherein the algal mineral is isolated from at least one alga of the genus Lithothamnion.

19. A method for producing a functional cheese, the method comprising adding a calcium composition during any of the steps of coagulating, draining, salting, and ripening during natural cheese processing, the calcium composition selected from the group consisting of at least one milk mineral composition comprising calcium, at least one plant mineral composition comprising calcium, at least one algal mineral composition comprising calcium, at least one bacterial mineral composition comprising calcium, at least one inorganic mineral composition comprising calcium and phosphate at a ratio of from about 4:1 to about 1:1, and combinations thereof.

20. The method of claim 19, wherein the calcium composition is added during the ripening step by recrumbling the natural cheese, adding the milk mineral, and reforming the cheese.

21. The method of claim 19, further comprising the step of heat-treating the functional cheese to produce a heat-treated cheese.

22. The method of claim 19, wherein the natural cheese is a cheese produced by adding at least one phospholipase to treat the cheese milk or adding at least one phospholipase as cheese is produced from the cheese milk.

23. A method for producing a functional cheese with increased calcium, the method comprising adding, at any of the steps of cheese manufacture selected from the group consisting of coagulating, draining, salting, ripening, recrumbling, and combinations thereof, a calcium composition selected from the group consisting of at least one milk mineral composition comprising calcium, at least one plant mineral composition comprising calcium, at least one algal mineral composition comprising calcium, at least one bacterial mineral composition comprising calcium, at least one inorganic mineral composition comprising calcium and phosphate at a ratio of from about 4:1 to about 1:1, and combinations thereof, thereby producing a functional cheese having a calcium level that is higher than that of natural cheese manufactured in the absence of added calcium.

24. A method for making a stretchy heat-treated cheese for use as a pizza topping, the method comprising admixing with at least one natural cheese from about 0.25 percent to about 5 percent (w/w) of milk mineral, the amount of milk mineral being sufficient to maintain sufficient casein-casein interactions to promote stretch, melting the cheese by the addition of heat to produce a melted cheese, and transferring the melted cheese to a device for cooling and forming the cheese.

25. The method of claim 24 wherein the natural cheese is a cheese produced by adding at least one phospholipase to treat the cheese milk or adding at least one phospholipase as cheese is produced from the cheese milk.

26. The method of claim 24 wherein the natural cheese is a Mozzarella cheese.
